(19) United States
(12) Patent Application Publication
(10) Pub. No.: US 2005/0172431 A1
(43) Pub. Date: Aug. 11, 2005

(54) Textile strip curtain for car wash systems

(76) Inventors: Gregor Kohlruss, Borken (DE); Hubert Wiesner, Sudholm (DE); Oliver Griebe, Rhode (DE)

Correspondence Address: WILLIAM COLLARD;COLLARD & ROE, P.C., 1077 NORTHERN BOULEVARD, ROSLYN, NY, 11576, US

(21) Appl. No.: 10/475,034

(22) PCT Filed: Apr. 5, 2002
(86) PCT No.: PCT/EP02/03782

(30) Foreign Application Priority Data
Apr. 17, 2001 (DE) 201 06 592.4

(51) Int. Cl. B60S 3/04

(52) U.S. Cl. 15/97.3

(57) ABSTRACT

The invention relates to a textile strip curtain for car wash systems, comprising a support rod (3) which can be driven back and forth and on which adjacent strips (1) made of water absorbent material are suspended. In order to increase water absorption in the textile strip curtain without increasing costs, the strips (1) are made of a long pile plush textile fiber material, whereby said plush material has a pile length of more than 10 mm.

The invention relates to a textile strip curtain for car wash systems, comprising a support rod which can be driven back and forth and on which adjacent strips made of a water absorbent material are suspended.

For the cleaning and care of motor vehicles, they are washed, waxed, and dried in automatic washing systems, such as portal washing systems. In this connection, either mobile or immobile cleaning devices are used.

In the case of conventional portal washing systems, the vehicle, which is at rest, is cleaned by means of the mobile cleaning devices. In contrast to this, in automatic washing lines, vehicles are towed through standing cleaning devices on rails, and washed.

Cloth strips, brushes, or bristles that belong to the cleaning device serve as cleaning elements for the washing process. The body of the vehicles is cleaned and washed by means of the back and forth movements of these cleaning elements. Afterwards, the vehicle is rinsed with water, and possibly waxed. As a final step, the vehicle is dried with a blower. However, not all of the water is removed with the blower, so that after the drying process, there are still drops of water or strips of water remaining on the vehicle, which then form spots as they evaporate.

Usually, therefore, in order to remove these residual water drops in washing lines, centered systems that run lengthwise, crosswise, or in rotation, or rotating rollers, are frequently used, which are fitted with textile strips. Textile strips made from nonwoven fabrics, woven fabrics, felts, or microfibers are already known, which are configured in such a way, in terms of material, design, and production, that they can absorb the remaining drops of water.

However, conventional textile strips made of nonwoven fabrics or felts have the disadvantage that they only possess a limited water absorption capacity and therefore allow the water to drip off again onto the vehicles to be treated, if the system is operated for an extended period of time, so that the undesirable water spots are formed again as a result of evaporation.

Three-layer textile strips in which the inside layer consists of compacted synthetic microfibers and the two cover layers consist of microfibers having a low water absorption capacity are known to be extremely absorbent, because of their capillary effects, but they are also very expensive. Here again, the absorption capacity is limited, in terms of volume, because of the absorption layer embedded between the two solid layers. Furthermore, the preparation of such textile strips for their next use is extremely complicated, since the absorbed water cannot easily be removed again. The water that has penetrated into gaps and grooves of the vehicle also cannot be removed, due to the rigidity of the microfiber textile strip.

It would therefore be desirable to configure a textile strip curtain with a textile material in such a manner that the aforementioned disadvantages can be avoided.

To accomplish this task, the invention proposes, proceeding from a textile strip curtain for car wash systems of the type stated initially, that the textile strips consist of a long-pile plush made of absorbent textile fibers.

By using long-pile plush made of absorbent textile fibers, the surface of the textile strip is enlarged and therefore the water absorption capacity is also improved. The long pile of the plush can penetrate even into regions of the vehicle that are difficult to reach, and can absorb the residual water from the gaps and grooves of the vehicle. Furthermore, removal of the absorbed residual water from the long pile, by means of wringing, spinning, and drying, is very simple, so that the textile strips are ready for use again very quickly.

Preferably, the fibers are made of viscose, cotton, microfibers, or mixtures of them. They have a titer of 0.5 dtex to 5 dtex, therefore a great water absorption potential is guaranteed.

It is practical if the cleaning plush has a pile length of more than 10 mm. In this way, the surface is increased, on the one hand and, on the other hand, the pile has the capacity of penetrating into gaps and grooves and absorbing the residual water.

A preferred embodiment of the invention is a cleaning plush configured as knitted goods; in this way, not only is the production structured in cost-effective manner, but also, the preparation of the textile strips for re-use is simplified.

It is practical if a tube-like textile strip is produced from a single piece of plush, by means of a seam on one side. With this embodiment, an attachment element, particularly a loop, can be connected with, preferably sewn onto, the top end of the textile strip. Therefore every textile strip can be removed from or hung onto the support rod, independent of the strips arranged next to it. Other attachment elements are also possible.

Preferably, the textile strips have a length of 200 cm and a width of 11 cm; they can, however, be changed as needed, according to corresponding requirements. The number of textile strips for the textile strip curtain can be determined as needed.

An exemplary embodiment of the textile strip curtain according to the invention will be briefly explained using drawings. These show:

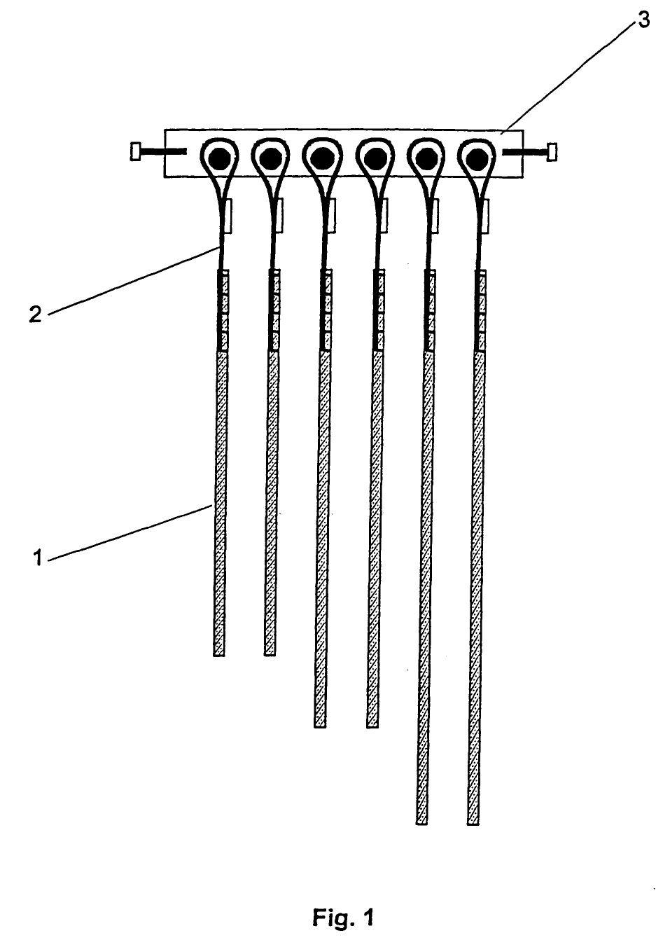

FIG. 1 a side view of a support rod with textile strips arranged next to one another;

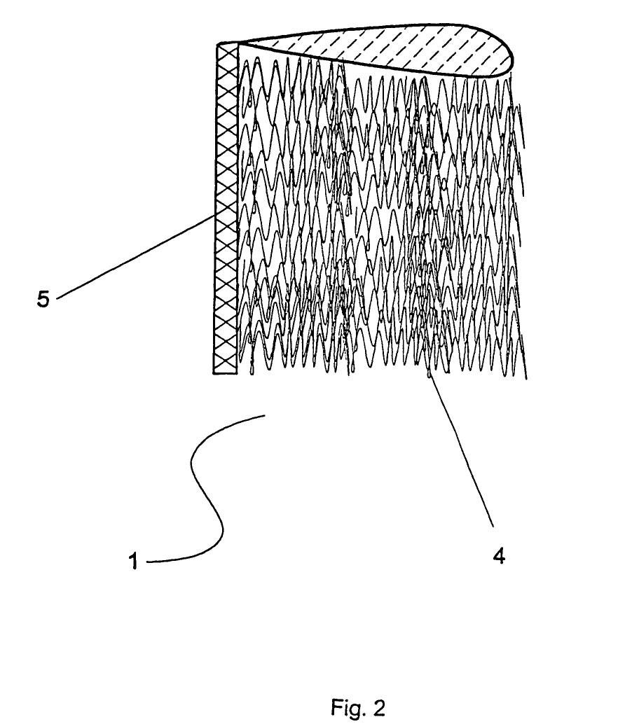

FIG. 2 a partial side view of the textile strip without an attachment element;

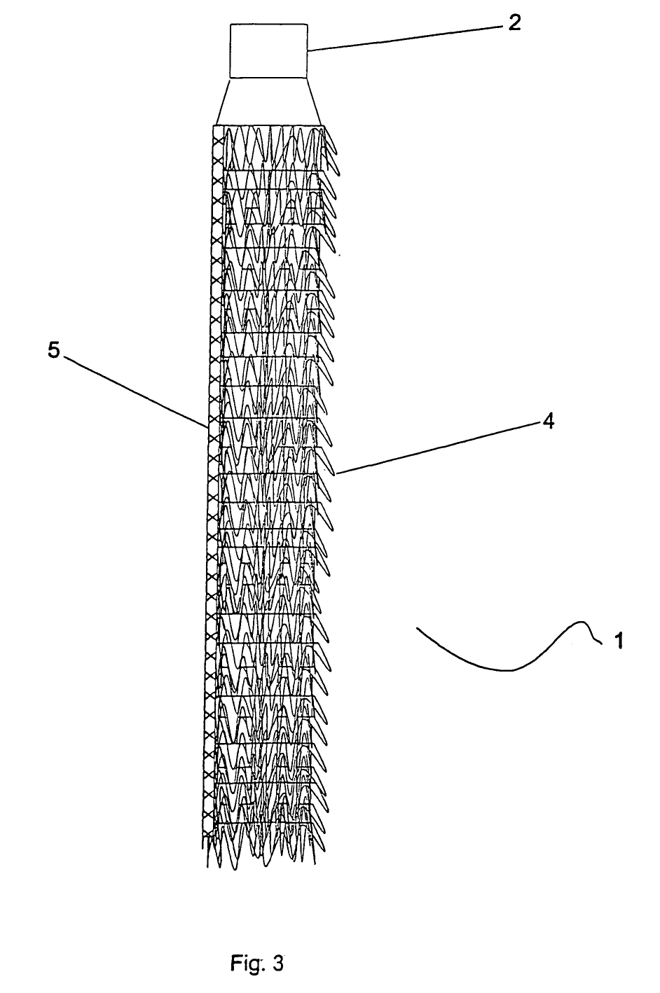

FIG. 3 a textile strip with an attachment element.

FIG. 1 shows a support rod 3 with textile strips 1 arranged next to one another, which are provided with attachment elements 2. Because of the different lengths of the textile strips, the optimal contact points between the plush pile and the car body are guaranteed.

FIG. 2 shows the top segment of the textile strip 1 without an attachment element. It is configured from a single piece of plush 4, to form a tube-like strip with plush surfaces on both sides, by means of a seam 5.

FIG. 3 shows the textile strip 1 having a seam 5 and the pile 4. At the top end, there is a partial piece of the attachment element 2, which can be easily connected with the textile strip, particularly sewn onto it.

1. Textile strip curtain for car wash systems, comprising a support rod which can be driven back and forth and on which adjacent strips made of a water absorbent material are suspended, characterized in that the strips consist of a long-pile plush made of absorbent textile fibers.

2. Textile strip curtain according to claim 1, characterized in that the absorbent textile fibers have a titer of 0.5 dtex to 5 dtex.

3. Textile strip curtain according to claim 1, characterized in that the absorbent textile fibers are made of viscose, cotton, microfibers, or mixtures of them.

4. Textile strip curtain according to claim 1, characterized in that the cleaning plush has a pile length of more than 10 mm.

5. Textile strip curtain according to claim 1, characterized in that the cleaning plush is knitted goods.
